(19) United States
(12) Patent Application Publication
(10) Pub. No.: US 2015/0201124 A1
(43) Pub. Date: Jul. 16, 2015

(54) CAMERA SYSTEM AND METHOD FOR REMOTELY CONTROLLING COMPOSITIONS OF SELF-PORTRAIT PICTURES USING HAND GESTURES

(71) Applicant: SAMSUNG ELECTRONICS CO., LTD., SUWON-SI (KR)

(72) Inventors: Shai Litvak, Beit Hashmonai (IL); Or Shimshi, Petah Tikva (IL)

(73) Assignee: SAMSUNG ELECTRONICS CO., LTD., SUWON-SI (KR)

(21) Appl. No.: 14/155,940

(22) Filed: Jan. 15, 2014

(51) Int. Cl. H04N 5/232

(52) U.S. Cl. CPC H04N 5/23219

(57) ABSTRACT

A camera system for taking a self-portrait picture includes a buffer memory and an image processor unit. The buffer memory stores a first image and a second image. Both images contain a human figure. In the first figure the human figure is standing in a command pose, and in the second image in a free pose. The image processor unit detects a human figure in the first image, determines whether the pose of the human figure is a command pose, detects a specific composition gesture pattern corresponding to pose of the human figure in the first image, determines the intended composition of the self-portrait picture using the detected composition gesture pattern, process the second image according to the intended composition, and stores the processed image.

### TECHNICAL FIELD

The present inventive concept relates to a camera system for taking a self-portrait picture and a method of controlling the same.

### DISCUSSION OF THE RELATED ART

Digital cameras may be used for taking self-portrait pictures. Such digital cameras may control their shooting time using a timer or motion detection. Such digital cameras may have a frontal screen in addition to a backscreen so that people can view their pose while the picture is being taken.

### SUMMARY

According to an exemplary embodiment of the inventive concept, a camera system for taking a self-portrait picture includes a buffer memory and an image processor unit. The buffer memory stores a first image and a second image. The image processor unit detects a human object from the first image, determines whether the human object is a command object, detects a composition gesture pattern of the command object from the first image, determines a composition of the self-portrait picture using the detected composition gesture pattern, and generates the second image having a posing object. The posing object is the same human object as the command object and has no composition gesture pattern.

According to an exemplary embodiment of the inventive concept, a camera system for taking a self-portrait picture includes a buffer memory and an image processor. The buffer memory stores a first image and a second image. The image processor unit detects a human object from the first image, determines whether the human object is a command object, calculates a first horizontal distance of one hand pattern of the command object from a corresponding body or face pattern, calculates a second horizontal distance of another hand pattern of the command object from the corresponding body or face pattern, calculates values of camera parameters using the first and the second horizontal distance, and generates the second image having a posing object. The posing object is a same human object as the command object.

According to an exemplary embodiment of the inventive concept, a method of controlling a camera system for taking a self-portrait picture is provided. First scene information is received using a first photographic frame. A first image corresponding to the first scene information is stored in a buffer memory. A human object is detected from the first image. Whether the human object is a command object is determined. The command object has an activation gesture pattern of a predefined hand pattern. When the command object is detected, a composition gesture pattern is detected from the command object. The composition gesture pattern is one of a plurality of predefined hand gesture patterns. One of a plurality of composition templates corresponding to the detected composition gesture pattern is selected. Each composition template corresponds to each predefined hand gesture pattern.

### BRIEF DESCRIPTION OF THE DRAWINGS

These and other features of the inventive concept will become more apparent by describing in detail exemplary embodiments thereof with reference to the accompanying drawings of which:

FIG. 1 shows that a person remotely controls a picture composition of a camera using its hand gesture when the camera is in a self-portrait photography mode according to an exemplary embodiment of this invention;

FIG. 2 shows a block diagram illustrating a camera system having a self-portrait photography mode according to an exemplary embodiment of the inventive concept;

FIG. 3 shows a block diagram illustrating a camera module of the camera system of FIG. 2 according to an exemplary embodiment of the inventive concept;

FIG. 4 shows a block diagram illustrating a camera interface of the camera system of FIG. 2 according to an exemplary embodiment of the inventive concept;

FIG. 5 shows a flowchart illustrating an operation flow when a camera system performs a mechanical operation in a self-portrait photography mode according to an exemplary embodiment of the inventive concept;

FIG. 6 shows a flowchart illustrating an operation flow when a camera system performs an image manipulation operation in a self-portrait photography mode according to an exemplary embodiment of the inventive concept;

FIG. 7 shows a flowchart illustrating the steps S130 and S140 of FIGS. 5 and 6 according to an exemplary embodiment of the inventive concept;

FIG. 8 shows an exemplary command object for illustrating the steps S130 and S140 of FIGS. 5 and 6 with reference to FIG. 7;

FIGS. 9A to 9E show various relative positions of a right-hand fist pattern with respect to a body or face pattern of a command object 610 according to an exemplary embodiment of the inventive concept;

FIGS. 10A to 10C show a composition gesture pattern indicating to a composition where a posing object is placed at the center of a picture image according to an exemplary embodiment of the inventive concept;

FIGS. 11A to 11F show a composition gesture pattern indicating to a composition where a posing object is placed at one side of a picture image according to an exemplary embodiment of the inventive concept;

FIGS. 12A to 12C show a composition gesture pattern indicating to a composition where a face pattern of a command object is enlarged in a picture image according to an exemplary embodiment of the inventive concept;

FIG. 13 shows a mechanical operation of the camera system 400 of FIG. 2 according to an exemplary embodiment of the inventive concept;

FIG. 14 shows an image manipulation operation of the camera system 400 of FIG. 2 according to an exemplary embodiment of the inventive concept;

FIGS. 15A to 15D show an extended command object according to an exemplary embodiment of the inventive concept;

FIG. 16 shows a flowchart illustrating the graded composition mode according to an exemplary embodiment of the inventive concept; and

FIGS. 17A to 17D show a single hand composition gesture pattern for controlling a basic shot of a video recording according to an exemplary embodiment of the inventive concept.

### DETAILED DESCRIPTION OF THE EMBODIMENTS

Exemplary embodiments of the inventive concept will be described below in detail with reference to the accompanying drawings. However, the inventive concept may be embodied in different forms and should not be construed as limited to the embodiments set forth herein. Like reference numerals may refer to the like elements throughout the specification and drawings.

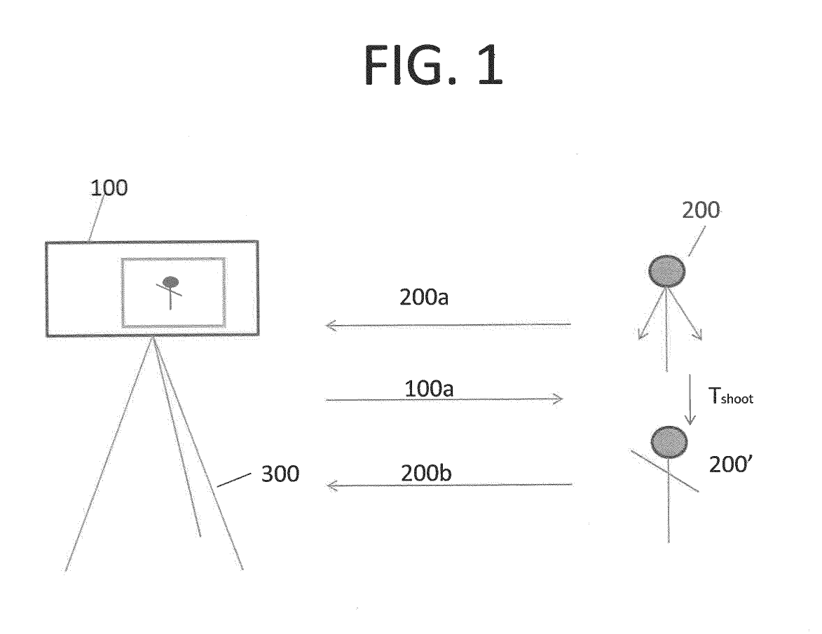

Hereinafter, a concept of a gesture based composition control for taking self-portrait photography with reference to FIG. 1.

FIG. 1 shows that a person remotely controls a picture composition of a camera using its hand gesture when the camera is in a self-portrait photography mode according to an exemplary embodiment of this invention.

Referring to FIG. 1, a camera 100 includes a camera system having a plurality of composition templates of a picture to be taken in a self-portrait photography mode. Each composition template includes information about a relative location and size of an object with respect to the background or to other objects in a picture to be taken. Each composition template also includes information about an image orientation (horizontal or vertical), size, and/or aspect ratio. Hereinafter, image pattern corresponding to a person is referred to as an object.

In the self-portrait photography mode, a command person, using its hand gesture, remotely selects a composition template of a picture to be taken. A single person or a group of persons may take a picture in the self-portrait mode. For a single person, the single person serves as the command person. For a group of persons, a single person or at least two persons of the group of persons serves as the command person. In this case, at least two persons collaborate to serve as the command person to control the camera 100.

For the convenience of description, the self-portrait photography mode will be described using a single person 200 serving as a command person. The command person 200 stands in front of the camera 100 and makes a hand gesture to the camera 100. The hand gesture of the command person 200 may include an activation gesture and a composition gesture. Using the activation gesture, the command person 200 indicates to the camera 200 that the command person 200 is in a control session for sending the composition gesture to the camera 100. The composition gesture indicates to one of the plurality of composition templates that the camera 100 provides.

During the control session, the command person 200 first sends an activation gesture to the camera 100 and then sends a composition gesture to the camera 100. The activation gesture includes making of two fists. The composition gesture includes a pre-defined hand gesture for a predetermined time, e.g., 4 seconds. The pre-defined hand gesture includes the two fists positioned at a relative position with respect to a body or face of the command person 200. In this case, the activation gesture of making two fists is part of the composition gesture. The activation or composition gesture is not limited thereto, and various body gestures may represent an activation or composition gesture. In response to the hand gesture, the camera 100 operates to take a picture according to a composition template selected using the composition gesture of the command person 200.

During the control session, the camera 100 receives first scene information 200a using a first photographic frame that is directed to the command object 200 and stores an image corresponding to the scene information 200a. The image of the scene information 200a is referred to as a command image. The command image includes a command object corresponding to the command person 200. The command object has an activation gesture pattern and a composition gesture pattern that correspond to the activation gesture and the composition gesture, respectively.

The camera 100, using the command image, detects the activation or composition gesture pattern, interprets the composition gesture pattern, and selects a composition template corresponding to the interpreted composition gesture pattern.

After the camera 100 recognizes the intent of the command person 200, the camera 100 ends the control session and generates a ready signal 100a to notify the command person 200 that the camera 100 is ready to take a picture. The ready signal 100a may include a beef sound or a flash light.

The command person 200, in response to the ready signal, becomes a posing person. 200′ who takes a natural pose for a picture to be taken. The camera 100 takes a picture of the posing person 200′ at a predetermined time Tₛₕₒₒₜ after the camera 100 generates the ready signal 100a.

At the predetermined time Tₛₕₒₒₜ, the camera 100 receives second scene information 200b and stores an image corresponding to the second scene information 200b. The image of the scene information 200b is referred to as a posing image. The posing image includes a posing object corresponding to the posing person 200′.

In an exemplary embodiment, the fist photographic frame of the camera 100 may be shifted to the second photographic frame corresponding to the selected composition template. In this case, the posing image may correspond to a picture image having the selected composition template. For example, the camera 110 may shift the first photographic flume to the second photographic frame using its mechanical operation such as a pan or tilt operation.

In an exemplary embodiment, the camera 100 receives the second scene information 200a without the mechanical operation for shifting the first photographic frame to the second photographic frame. In this case, the camera receives the second scene information using the first photographic frame. The camera 100, then, performs an image manipulation operation on the posing image to generate a picture image having the selected composition template.

Finally, the camera 100 compresses the picture image using a data compress format and may store the compressed picture image into a storage unit thereof.

As described above with reference to FIG. 1, the camera system 400 generates a command image, a posing image, and a picture image from receiving scene information. The command image includes a command object having an activation gesture pattern and/or a composition gesture. The command object corresponds to the command person 200 of FIG. 1. The posing image includes a posing object that corresponds to a posing person 200′ of FIG. 1. After the command person 200′ successfully sends a composition gesture to the camera 100, the command person 200′ releases its composition gesture and takes a natural pose. The command person 200′ becomes the posing person 200′. The picture image has the posing object according to a composition intended by the command person 200. In an exemplary embodiment, the posing image is the same as the picture image.

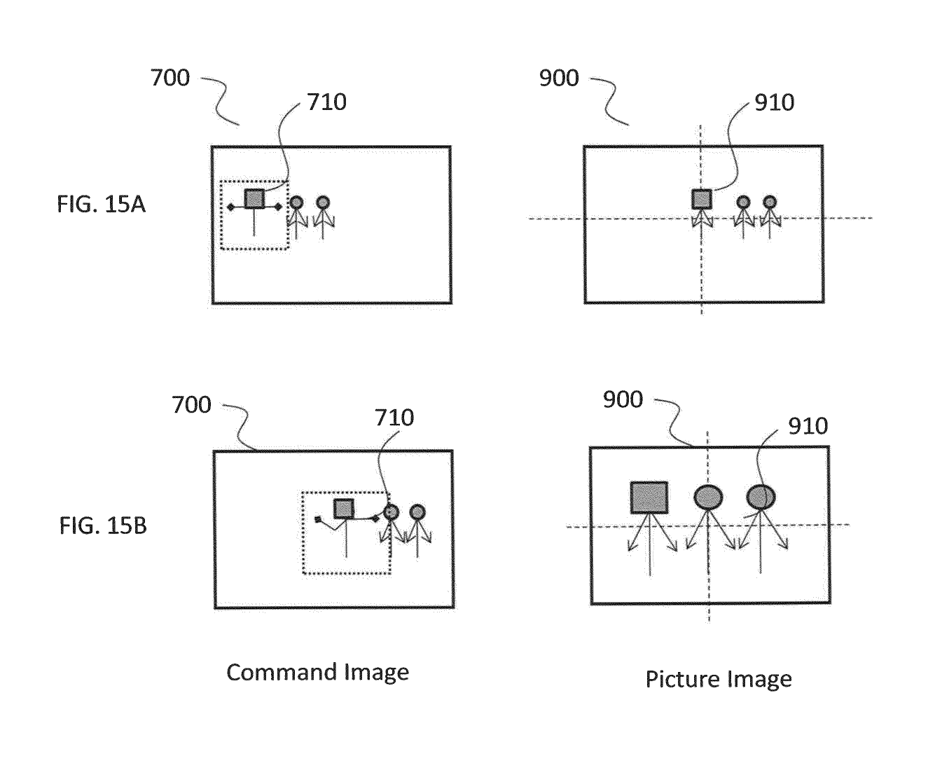

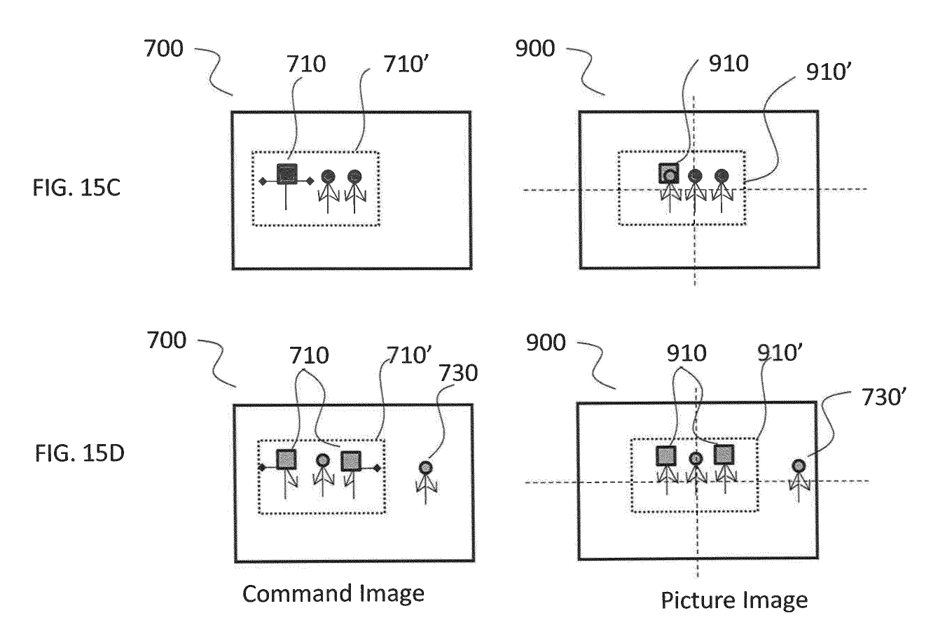

The camera 100 has a plurality of group photography options in the self-portrait photography mode. Depending on a group photography option, a command object is defined in various ways. Details of the group photography options will be described with reference to FIGS. 15A to 15D.

In an exemplary embodiment, the camera 100 may generate a first ready signal and a second ready signal. The first ready signal may be generated after the selection of a composition template. The second ready signal, followed by the first read signal, may be generated before a shooting signal is generated.

A command image, a posing image, or a picture image may be uncompressed.

In an exemplary embodiment, the self-portrait photography mode may be incorporated in a portable electronic device other than a camera. For example, the portable electronic device may include, but is not limited to, a smart phone, a tablet or a notebook computer.

Accordingly, a camera having a self-portrait photography mode takes a picture having a composition that a command person remotely selects using its hand gesture, and thus the self-portrait photography mode according to an inventive concept removes or reduces a post-processing step to change a composition of a picture. Further, the camera, in the self-portrait photography mode, may perform an image processing operation, such as digital upscaling, on an uncompressed image, thereby increasing picture quality compared to post processing of a compressed image. The self-portrait mode may also eliminate the post processing time.

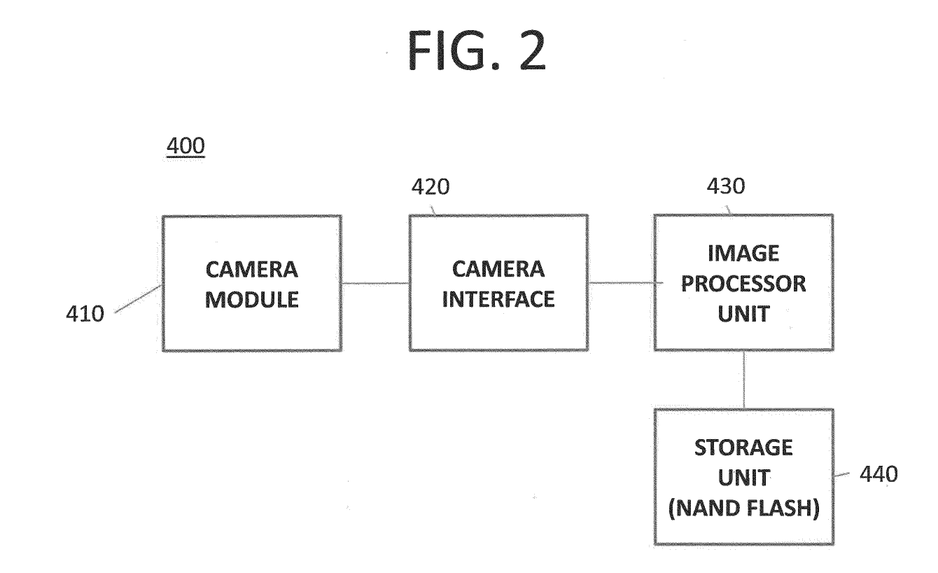

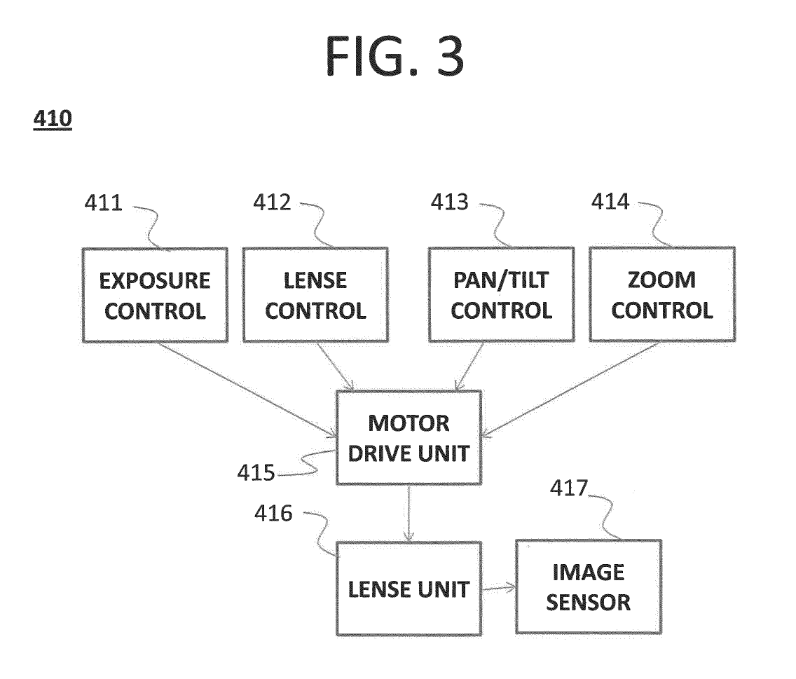

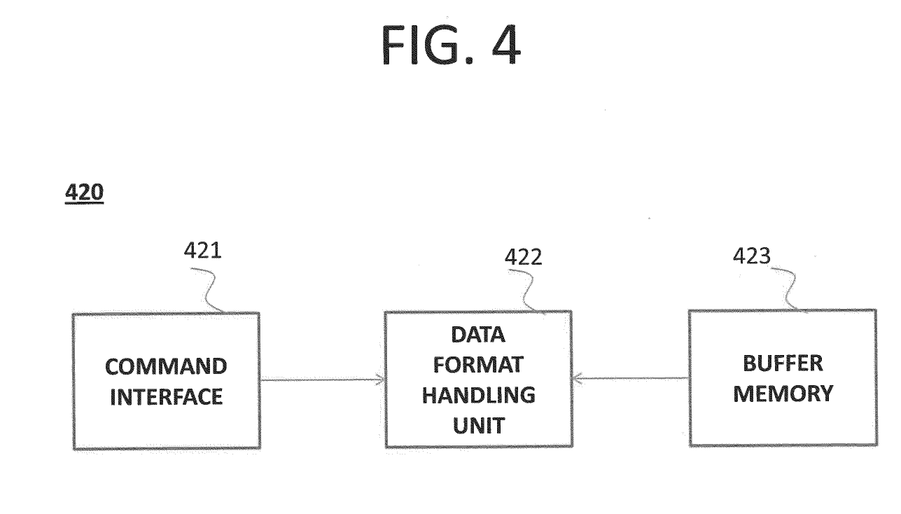

Hereinafter, a camera system having a self-portrait photography mode will be described with reference to FIGS. 2-4. FIG. 2 shows a block diagram illustrating a camera system having a self-portrait photography mode according to an exemplary embodiment of the inventive concept. FIG. 3 shows a block diagram illustrating a camera module of the camera system of FIG. 2 according to an exemplary embodiment of the inventive concept. FIG. 4 shows a block diagram illustrating a camera interface of the camera system of FIG. 2 according to an exemplary embodiment of the inventive concept.

Referring to FIG. 2, a camera system 400 includes a camera module 410, a camera interface 420, an image processor unit 430, and a storage unit 440. The camera system 400 is incorporated into the camera 100 as shown in FIG. 1. The camera system 400 may be incorporated into an electronic device having a camera function. The electronic device may include, but is not limited to, a smart phone, a tablet or a notebook computer.

In operation, the image processor unit 430 selects a composition template of a picture to be taken in the self-portrait photography mode as described in FIG. 1. In doing so, the image processor unit 430 analyzes a command image to detect an activation or composition gesture that represents the intent of the command person 200 of FIG. 1. The image processor unit 430 further calculates a relative location and size of the command object in the command image.

In a case that the camera 100 takes a picture of a single person in the self-portrait photography mode, the single person serves as a command person, and the image processor unit 430 calculates a relative location and size of the command object.

In a case where the camera 100 takes a picture of a group of persons in the self-portrait photography mode, a single, two, or more persons of the group of persons serves as a command person. The image processor unit 430 calculates a relative location and size of the command object in various ways. Detailed description about the calculation will be described with reference to FIGS. 15A to 15D.

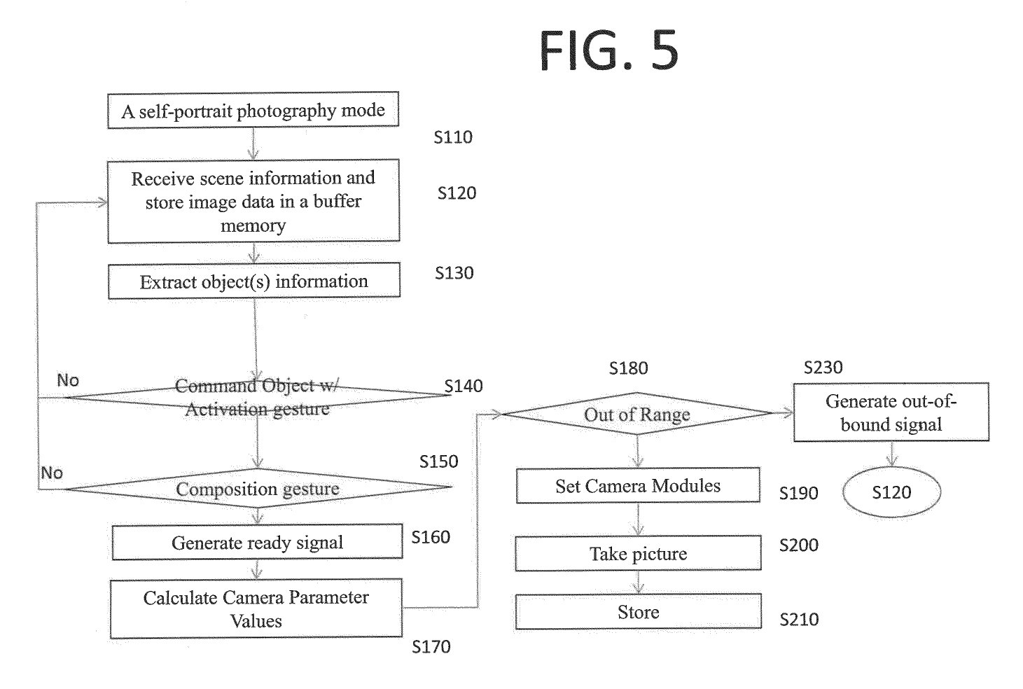

In an exemplary embodiment, the image processor unit 430 controls a mechanical operation such as a pan, tilt or zooming operation. For example, the image processor unit 430 selects a composition template according to a composition gesture pattern. The image processor unit 430 sets camera parameters according to the selected composition template so that the camera 100 of FIG. 1 receives the second scene information 200b′ using the second photographic frame. The second photographic frame corresponds to the selected composition template. Further, the image processor unit 430 controls other parameters such as an exposure or focal depth of a lens. The image processor unit 430 also controls a shooting time for taking a picture after having selected the composition template. Details of an operation of the image processor unit 430 will be described with reference to FIG. 5.

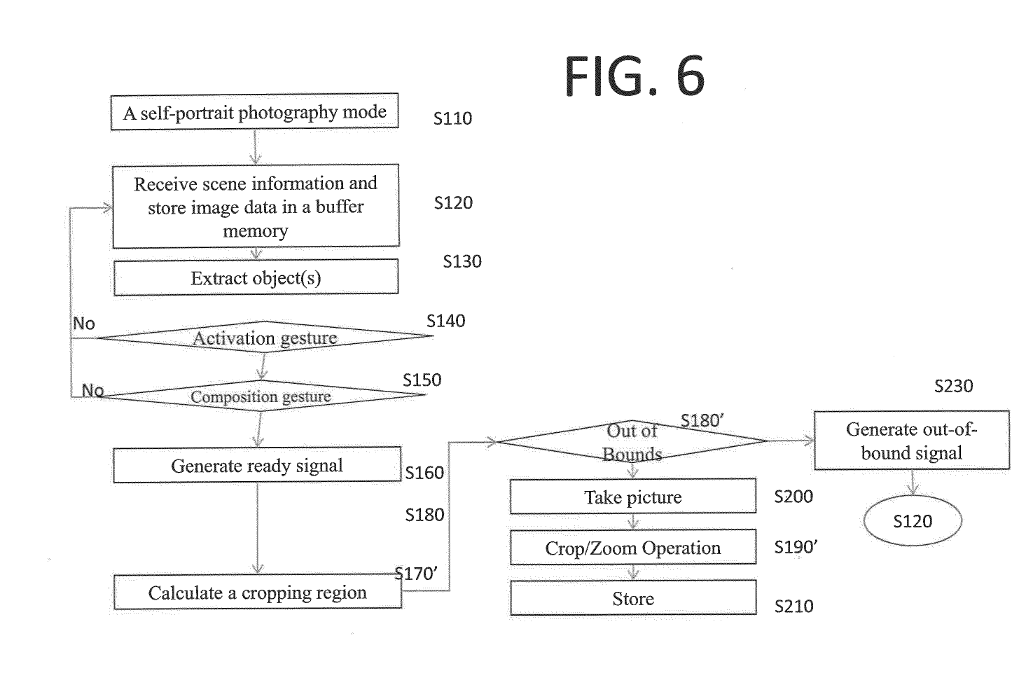

In an exemplary embodiment, the image processor unit 430 of FIG. 2 manipulates a posing image to generate a picture image having the selected composition template. The posing image includes a posing object corresponding to the posing person 200′ of FIG. 1, but the posing image does not have a selected composition template. For example, the camera 100 of FIG. 1, without controlling a mechanical operation of the camera system 400, stores the posing image having substantially the same photographic frame with that of the command image. The camera system, without using the mechanical operation, manipulates the posing image to generate a picture image having the selected composition template. Details of an operation of the image processor unit 430 will be described with reference to FIG. 6.

In an exemplary embodiment, the image processor unit 430 of FIG. 2 performs both the mechanical operation and the image manipulation operation to generate a picture image. For example, the image processor unit 430 may have a posing image with insufficient information for the selected composition template. In such case, an image manipulation operation such as a cropping operation might not deliver a picture image having the selected composition template. To include the missing field of view in the frame, the image processor unit 430 may perform a mechanical operation such as a pan or tile operation to move the body of camera 100 and direct it towards the required area.

Referring to FIG. 3, the camera module 410 includes an exposure control 411, a lens control 412, a pan/tilt control 413, a zoom control 414, a motor drive unit 415, a lens unit 416 and an image sensor 417. The camera module 410 may further include a flash control unit and an audio control unit.

In operation, the camera module 410 serves to convert the first scene information. 200a of FIG. 1 to a command image. The lens unit 416 receives the first scene information 200a and provides the first scene information 200a to the image sensor 417. For example, the image sensor may include a CMOS (Complementary Metal Oxide Semiconductor) image sensor. An analog-to-digital converter (not shown) coupled to the image sensor 417 converts the first scene information to the command image.

Similarly, the camera module 410 serves to convert the second scene information 200b of FIG. 1 to a posing image or a picture image.

Referring to FIG: 4, the camera interface 420 includes a command interface 421, a data format handling unit 422, and a buffer memory 423. The command interface 421 generates various commands necessary to control the camera module 410. For example, the command interface 421 is subject to control of the image processor unit 430 and generates a command for a pan operation, a command for a tilt operation, a command for a zooming operation, a command for exposure control or a command for focal length control. The data format handling unit 422 compresses a picture image stored in the buffer memory 423 according to a data format including, but not limited to, a JPEG format. The buffer memory 423 stores a command image, a posing image or a picture image while the image processor unit 430 performs a self-portrait photography mode according to an exemplary embodiment.

The camera system 400 may be embodied in various ways. The camera system 400 may be built on a printed circuit hoard, where the functional blocks 410, 420, and 430 each is separately packaged. The camera system 400 may be integrated in a single chip or may be packaged in a single package. Part of the camera module 410 such as the lens unit 416 need not be integrated in a single chip or need not be packaged in a single package.

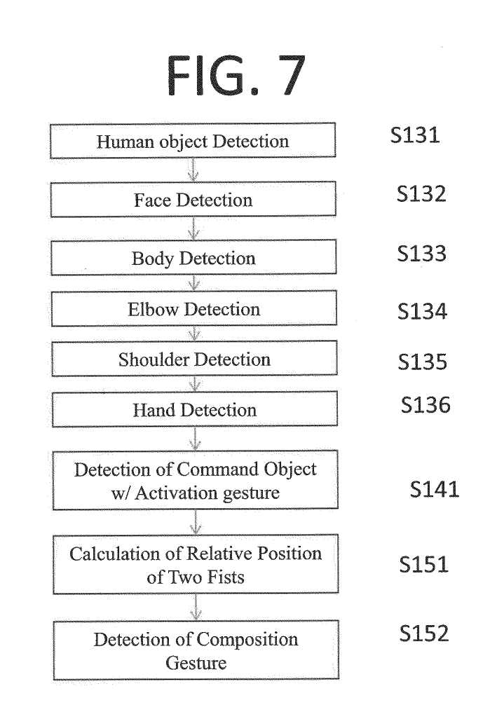

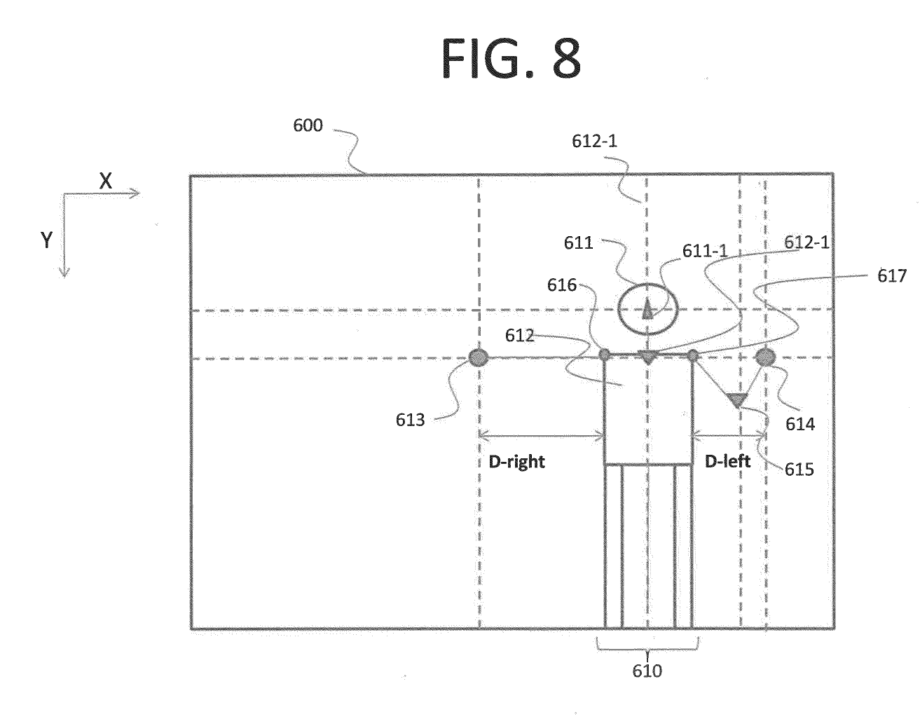

Hereinafter, an operation flow of the camera system 400 will be described in detail with reference to FIGS. 5 to 8. FIG. 5 shows a flowchart illustrating an operation flow when a camera system performs a mechanical operation in a self-portrait photography mode according to an exemplary embodiment of the inventive concept. FIG. 6 shows a flowchart illustrating an operation flow when a camera system performs an image manipulation operation in a self-portrait photography mode according to an exemplary embodiment of the inventive concept. FIG. 7 shows a flowchart illustrating the steps S130 and S140 of FIGS. 5 and 6 according to an exemplary embodiment of the inventive concept. FIG. 8 shows an exemplary command object for illustrating the steps S130 and S140 of FIGS. 5 and 6 with reference to FIG. 7.

Referring to FIG. 5, the operation flow of the camera system 400 of FIG. 2 is started with the step S110 when a self-portrait photography mode is set on the camera. For example, a camera may include a button for selecting the self-portrait photography mode. Alternatively, the camera may provide a touch-screen menu including the self-portrait photography mode.

When the camera 110 of FIG. 1 takes a group of persons in the self-portrait photography mode, one of a plurality of group photography options, at the step S110, is selected. Details of the group photography options will be described with reference to FIGS. 15A to 15D.

At the step S120, the camera system 400 receives scene information 200a using the lens unit 416 and converts the scene information to a corresponding image using the image sensor 417. The image is stored in the buffer memory 423. The camera system 400 may successively receive scene information and successively store its corresponding image in the buffer memory 423 until the camera system 420 detects an activation or composition gesture pattern from the image. The image having an activation or composition gesture pattern is referred to as a command image.

At the step S130, the image processor unit 430 of FIG. 2 extracts an object from the image stored in the buffer memory 423. The image processor unit 430 performs a foreground-background segmentation algorithm on the image to extract a foreground object from the image. The foreground-background segmentation algorithm may use color, depth, or motion segmentation of the image to divide the image into the foreground image and the background image. The foreground-background segmentation algorithm may be formulated in various ways. At this step, the image processor unit 430 extracts a human object from the foreground image using a visual object recognition algorithm. For example, when the foreground image includes a moving object such as a running dog other than a human object, the image processor unit 430 detects a human object using the visual object recognition algorithm. The visual object recognition algorithm may be implemented based on a robust feature set that allows the human object to be discriminated cleanly from the background or other non-human objects in the image.

The image processor unit 430 also detects various parts of the command person 200 of FIG. 1 including, for example, the face, the body, the hands, the shoulder or the elbow using a body part detection algorithm. The step S130 will be described in detail with reference to FIGS. 7 and 8.

At the step S140, the image processor unit 430 of FIG. 2 detects a command object having an activation gesture pattern using a hand posture detection algorithm. Using the hand posture detection algorithm, the image processor unit 430 analyzes whether a hand gesture pattern of the object that is extracted at the step S130 has an activation gesture pattern. The hand posture detection algorithm may be implemented at the step S130 to detect a hand gesture pattern.

For example, the activation gesture pattern includes two fist patterns of an object or a combination of one left fist pattern of one object and one right fist pattern of another object. The activation gesture pattern includes, but not limited to, a fully-opened-hand-with-stretched-fingers gesture pattern, an index finger-pointing-away-from-the-body gesture pattern or a thumb-up or thumb-down gesture pattern.

When the image processor unit determines that the hand gesture pattern includes the activation gesture, the image processor unit treats the object as a command object.

When the camera 110 of FIG. 1 takes a picture of a single person, the image processor unit 430 detects the object corresponding to the single person as a command object. When the camera 110 of FIG. 1 takes a group of persons, the image processor unit 430 detects one or more objects as a command object according to one of the group photography options,

The image processor unit, failing to detect an activation gesture pattern, repeats the steps S120 to S140 until detecting an activation gesture pattern in the command image.

At the step S150, the image processor unit 430 of FIG. 2 detects a composition gesture pattern of the command object using the hand posture detection algorithm. Alternatively, the image processor unit 430 may use a look-up table having information about the pre-defined composition gesture patterns. A composition gesture pattern of the command object indicates to one of the composition templates for a picture to be taken in the self-portrait photography mode.

For example, the image processor unit 430, uses a pattern matching algorithm, compares the hand gesture pattern detected by the hand posture detection algorithm and the pre-defined composition gesture patterns. When the image processor unit 430 determines that the hand gesture matches one of the composition gesture patterns, the image processor units 430 further determines that the matched gesture pattern remains stable for a predetermined time. When the image processor unit 430 determines that the hand gesture matches composition gesture, the image processor unit 430 proceeds to the step S160.

The image processor unit, failing to detect one of the pre-defined composition gesture patterns, repeats the steps S120 to S150 until detecting an activation or composition gesture pattern. The image processor unit 430 may sequentially repeat the step S120 after performing the steps S140 or S150. Alternatively, the image processor unit 430 may perform the step S120 and the steps S130 to S150 in parallel. For example, the image processor unit 430 repeats the step S120 at a predetermined time interval during performing the steps S130 to S150.

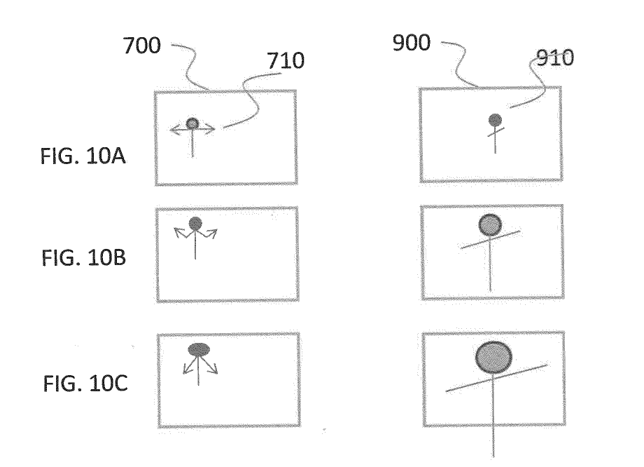

The composition gesture patterns may be formulated in various ways. The exemplary composition gesture patterns will be described in detail later with reference to FIGS. 10A to 10C, 11A to 11F and 12A to 12C.

The step S150 will be described in detail with reference to FIGS. 7 and 8.

At the step S160, the image processor unit 430 of FIG. 2 generates a ready signal for indicating that the camera 100 of FIG. 1 is ready to take a picture. In response to the ready signal, the command person 200 of FIG. 1 releases its composition gesture and becomes the posing person 200′ of FIG. 1. The posing person 200′ of FIG. 1 takes a natural pose for a picture to be taken in the self-portrait photography mode. For example, the ready signal may include a beep sound or a flashing light.

At the step S170, the image processor unit 430 of FIG. 2 selects a composition template corresponding to the composition gesture and calculates camera parameter values for a mechanical operation of the camera system 400. For example, the image processor unit 430 calculates the relative location and size of the command object in the command image. The selected composition template includes information about a relative position and size of a posing object in the picture image. The image processor unit 430 calculates how much the photographic frame is shifted to place the command object at a location of the selected composition template. In addition, the image processor unit 430 calculates zoom scale by comparing the relative size of the command object and the relative size of the posing object defined in the selected composition template.

The location of the command object is determined using a face pattern position of the command object. The location is not limited thereto, and the location may be determined using a center of mass of the command object.

At the step S180, the image processor unit 430 of FIG. 2 determines whether the calculated camera parameters are within an allowed range of the camera parameters. When the camera parameter values are within the range of the camera parameters, the image processor unit 430 performs the step S190. Otherwise, the image processor unit 430 proceeds to the step S230.

At the step S230, the image processor unit 230 of FIG. 2 generates an out-of-range signal. In response to the out-of-range signal, the command person 200 of FIG. 1 may change its location. The image processor unit 430 repeats the steps S120 to S180. In an exemplary embodiment, the out-of-range signal may include a beep sound or a flash light.

At the step 190, the application process 430 of FIG. 2 controls the camera module 410 using the camera interface 420 according to the calculated camera parameter values. The camera module 410, using the camera parameter values, performs a mechanical operation such as a tilt operation, a pan operation, or a zoom operation so that the picture image has the selected composition template.

In an exemplary embodiment, the steps S160 to S180 are sequentially performed. The sequence of the steps S160 to S180 is not limited thereto, and it may be performed in different sequences. For example, the step S160 and the step S170 may be simultaneously performed. Alternatively, the step S160 may be performed after the steps S170 to S190.

At the step S200, the image processor unit 430 of FIG. 2 generates a shooting command and issues the shooting command to the camera module 410 using the camera interface 420. A picture image is stored in the buffer memory 423. The picture image has a posing object having a size and location that is defined by the selected composition template.

The shooting command is generated a predetermined time after the camera system has generated the ready signal. The predetermined time may be set as an amount of time that is necessary for the posing person 200′ of FIG. 1 to take a pose in response to the ready signal.

At the step S210, the picture image is compressed in a compressed data format, and the compressed picture image, then, is stored in the storage unit 440 of FIG. 2. In an exemplary embodiment, the storage unit 440 may include a nonvolatile memory.

In an exemplary embodiment, when a camera system supports a mechanical operation such as a pan, tilt, or zooming operation, the camera system remotely takes a picture in a self-portrait photography mode, allowing a photographer to remotely select a composition template of a picture to be taken. The camera system calculates camera parameter values for a pan, tilt or zooming operation based on the selected composition template. The camera system, using the camera parameter values, performs a mechanical operation to frame the command person according to the selected composition template, for example by moving the camera body and/or lens accordingly.

Hereinafter, it will be described that the image processor unit 430 of FIG. 2, in a self-portrait photography mode, performs an image manipulation operation on a posing image. The image manipulation operation includes a cropping operation and a digital zooming operation. In an exemplary embodiment, the cropping operation may be followed by the digital zooming operation.

The operation flow of FIG. 6 is substantially similar to that of FIG. 5, except that the image processor unit 430 performs a cropping operation instead of a mechanical operation. The following description will focus on the cropping operation. In the self-portrait photography mode entered at the step S110, image processor unit 430 of FIG. 2 performs the steps S110 to S160 as described with reference to FIG. 5.

At the step S170′, the image processor unit 430 selects a composition corresponding to a composition gesture and calculates a cropping region. The cropping region will be applied to a posing image that is generated at the step S200 to generate a picture image having the selected composition template.

At the step S180′, the image processor unit 430 of FIG. 2 determines whether the cropping region is located within the boundary of the command image. When the cropping region includes a region outside the command image, the camera image processor unit 430 generates an out-of-bounds signal at the step S180′.

In response to the out-of-bounds signal, the command person 200 of FIG. 1 may change its location or its composition gesture. The image processor unit 430, then, repeats the steps S120 to S180′ to calculate a new cropping region. When the cropping region is within the boundary of the command image, the image processor unit proceeds to the step S200.

At the step S200, the camera 100 of FIG. 1 takes a picture of the posing person 200′ having a natural pose in response to the ready signal of the step S160. The image processor unit 430 stores a posing image in the buffer memory 423. The posing image includes a posing object corresponding to the posing person 200′, but the posing image does not have the selected composition template. For example, the posing object might not be placed at a location of the posing image according to the selected composition template.

At the step S190′, the image processor unit 430 of FIG. 2 manipulates the posing image by performing a cropping operation using the cropping region. For example, the image processor unit 430 selects part of the posing image corresponding to the cropping region. The selected part of the posing image, which is referred to as a cropped region, has the selected composition template. The cropped region is enlarged by a digital zooming operation to create a picture image. In an exemplary embodiment, the cropped region may have substantially the same aspect ratio with the picture image. Alternatively, when the cropped region has a different aspect ratio with the picture image, the cropped region may be further transformed to have the aspect ratio of the picture image.

At the step S210, the picture image is compressed using a data format and the compressed picture image is stored in the storage unit 440. The storage unit 440 may include a non-volatile memory device.

The camera system may perform both a mechanical operation and an image manipulating operation to generate a picture image. For example, when a cropping region includes a region outside the command image, a mechanical operation such as a pan, tilt or zooming operation is performed so that a new cropping region is defined within the boundary of a new command image.

Referring to FIGS. 7 and 8, the steps S130 to S150 of FIG. 5 will be described in detail. For convenience of description, it is assumed that the camera receives scene information having a single person. The scene information may be stored in the buffer memory 423 as an image having an aspect ratio including 4:3, 3:2 or 16:9.

At the steps S131 to S136, the image processor unit 430 of FIG. 2 detects various parts of a human object using a body part detection algorithm. At the step S131, the image processor unit 430 extracts a foreground image from an image 600 and detects a human object 610 from the foreground using a human body detection algorithm. For example, when the image corresponding to the first scene information 200a of FIG. 1 includes a moving object other than the command person 200, the image processor unit 430 detects a human object from the foreground image using the human body detection algorithm. The human body detection algorithm may be formulated using various human features. A relative size of the human object 610 may be calculated by an area that the human object 610 occupies in the image 600. A relative location of the human object 610 may be calculated by a body part pattern location of the human object 610. Alternatively, a relative location of the human object 610 may be calculated by a location of a face location of the human object 610.

At the step S132, the image processor unit 430 detects a face pattern 611 of the human object 610 and calculates a coordinate of a face pattern location in an X-Y coordinate system of the image 600. In an exemplary embodiment, the image processor unit 430 treats the face pa tern location as a location of the human object 610. The face pattern location may be represented by a nose pattern location.

At the step S133, the image processor unit 430 detects a body pattern 612 of the human object 610 and calculates a coordinate of a body pattern location in the X-Y coordinate system. The image processor unit 430 may treat the body pattern location as a location of the human object 610. The body pattern location may be represented by a point 612-1 where an imaginary line 612-1 passing a nose pattern 611-1 crosses the body pattern 612. For example, the crossing point 612-1 that is close to the nose location 611-1 represents the body pattern location.

At the step S134, the image processor unit 430 of FIG. 2 detects an elbow pattern 615 of the human object 610 and calculates a coordinate of an elbow pattern location in the X-Y coordinate system. In an exemplary embodiment, the elbow pattern location is represented by a bottom point of a V-shaped line between the body pattern 612 and a hand pattern 613 and 614.

At the step S135, the image processor unit 430 of FIG. 2 detects two shoulder patterns 616 and 617 of the human object 610 and calculates coordinates of the shoulder pattern locations in the X-Y coordinate system. In an exemplary embodiment, the shoulder pattern locations are represented by upper corners of the body pattern 612.

At the step S136, the image processor unit 430 of FIG. 2 detects two hands 613 and 614 of the human object 610. In an exemplary embodiment, the image processor unit 430 may detect a finger pattern of the two hands 613 and 614. In that case, the command person 200 of FIG. 1 may formulate a band gesture using its finger.

At the step S141, the image processor unit 430 of FIG. 2 detects presence of a command object using a hand posture detection algorithm. Detecting an activation gesture pattern, the image processor unit 430 treats the image 600 as a command image and the human object 610 as a command object. The activation gesture pattern includes two fist patterns 613 and 614. The activation gesture pattern is not limited to two fists patterns, and may include, but is not limited to, two open palm patterns or finger patterns. The image processor unit 430 calculates coordinates of two fist patterns' locations in the X-Y coordinate system. The fist pattern location is represented by a center of a fist pattern.

The image processor unit 430 also calculates the location of the command object 610. For example, the face or the body pattern location may be treated as the location of the command object 610.

The image processor unit 430 also calculates the relative size of the command object 610 in the command image 610, in an exemplary embodiment, the relative size of the command object 610 may be calculated by dividing the area of the command object 610 by the area of the command image 610. The area of the object 610 may be calculated using the foreground-background segmentation algorithm.

The steps S131 to S136 apply when an image 600 includes two or more human objects. For example, when one of the two or more human objects has two fist patterns, the image processor unit 430 treats the human object having two fist patterns as a command object and treats other human objects as part of the background. Accordingly, the application process 430 performs the operation flows of FIG. 5 or 6 using the selected command object from the two or more human objects.

However, the command object may include other human objects having no activation gesture pattern (e.g., two fists) or may include at least two human objects each having one fist pattern. The camera of FIG. 1 has a plurality of group photography options to define the scope of the command object. Detailed description of the group photography options will be made later with reference to FIGS. 15A to 15D.

The sequence of the steps S131 to S134 is not limited thereto, and the steps S131 to S134 may be performed in various sequences. For example, when an image has two or more human objects, the image processor unit 430 may first perform the steps S134 and S141 on the human objects until detecting a command object. Then, the image processor unit 430 applies the remaining steps S131 to S133 to the command object only.

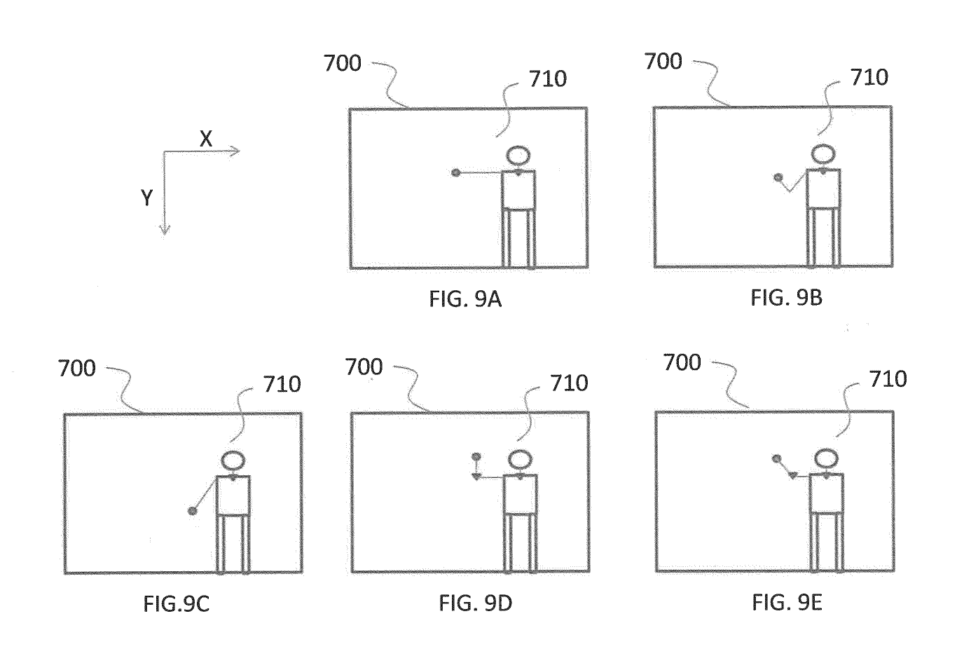

At the step S151, the image processor unit 430 of FIG. 2 determines a relative position of each of the two fist patterns 613 and 614. The relative position may be formulated using a relationship of a fist pattern with a body or face pattern of the command object. For example, the relative position of each of the two fiat patterns may include a fully-stretched position, a half-stretched position, a fist-down position, a fist-up position, or a partially-extended-fist-up position. The relative position will be described in more detail using FIGS. 9A to 9E.

At the step S152, the image processor unit 430 of FIG. 2 detects a composition gesture pattern indicating to one of pre-determined compositions of a picture to be taken in the self-portrait photography mode. For example, the image processor unit 430 may use a look-up table having information about a plurality of pre-determined composition gesture patterns. Alternatively, the image processor unit 430 may perform a hand posture detection algorithm to determine whether the command object has one of the pre-determined composition gesture patterns.

Hereinafter, a relative position of one fist pattern will be described in more detail using FIGS. 9A to 9E. A composition gesture pattern includes two or more fist patterns.

For a single command object, a composition gesture pattern includes two fist patterns. When two human objects serve as a command object, each human object provides one fist pattern for making a composition gesture pattern.

FIGS. 9A to 9E show various relative positions of a right-hand fist pattern with respect to a body or face pattern of a command object 610 according to an exemplary embodiment of the inventive concept. The activation or composition gesture patterns include at least two fist patterns. The two fist patterns may be detected from a single human object or the two fist patterns may be detected from two human objects each providing a single fist pattern. For convenience of description, the various relative positions will be described with reference to the right-band fist pattern only.

Referring to FIGS. 9A to 9E, the relative positions of the right-hand fist pattern of a command image 700 includes, but not limited to, a fully-stretched position (FIG. 9A), a half-stretched position (FIG. 9B), a fist-down position (FIG. 9C), a fist-up position (FIG. 9D), or a partially-extended-fist-up position (FIG. 9E).

The image processor unit 340 of FIG. 2 performs a pose estimation algorithm on the command image using image information including, but not limited to, color, depth, or motion segmentation, to detect the various relative positions. The accuracy of a pose estimation algorithm may be increased when using both color and depth segmentation.

The image processor unit 430 of FIG. 2, at the step S151 of FIG. 7, detects relative positions of two fist patterns as described above, and the image processor unit 430, at the step S152 of FIG. 7, determines a combination of the relative positions of the two fist patterns using the look-up table or the hand posture detection algorithm. A combination of the relative positions of the two fist patterns represents one of the pre-defined composition gesture patterns.

Hereinafter, detailed description of a composition gesture pattern will be made with reference to FIGS. 10A to 10C, FIGS. 11A to 11E, and FIGS. 12A to 12C.

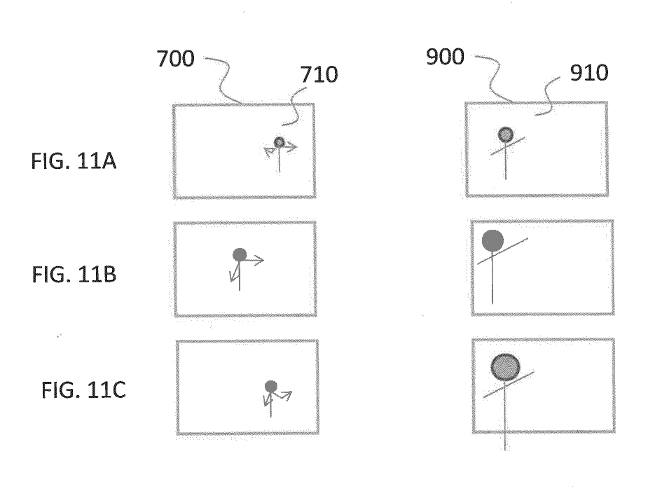

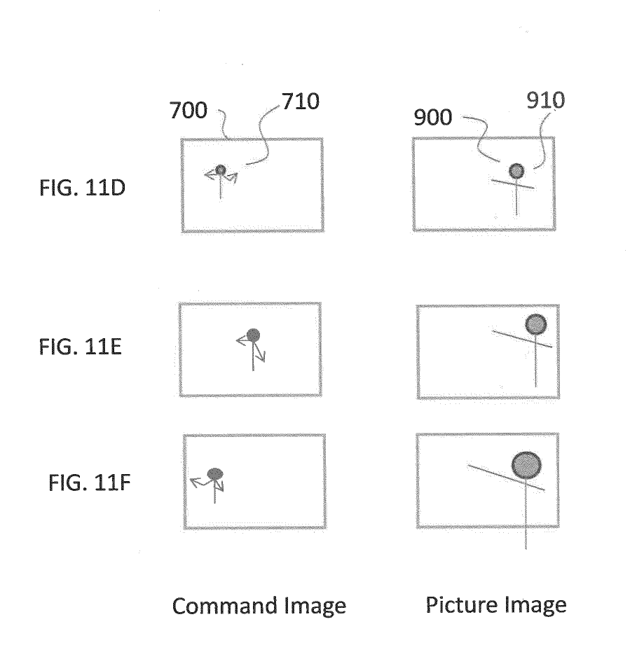

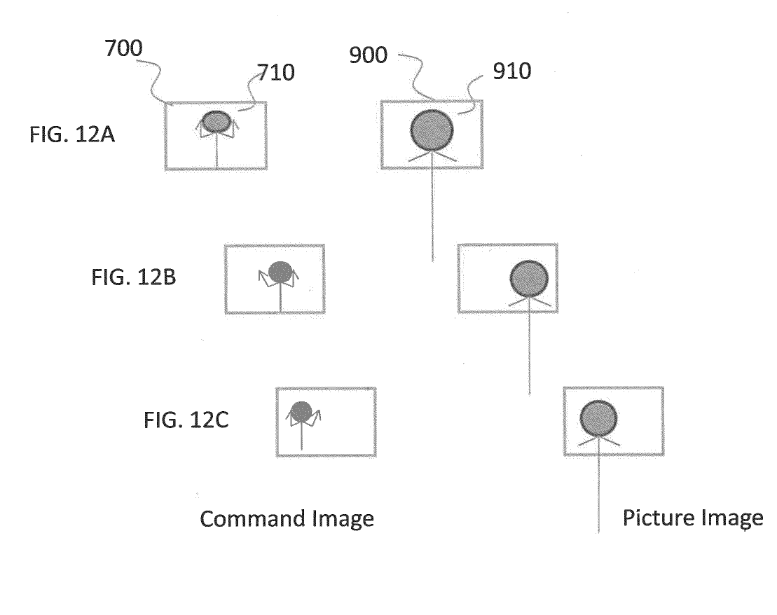

FIGS. 10A to 10C show a composition gesture pattern indicating to a composition where a posing object is placed at the center of a picture image according to an exemplary embodiment of the inventive concept. FIGS. 11A to 11E show a composition gesture pattern indicating to a composition where a posing object is placed at one side of a picture image according to an exemplary embodiment of the inventive concept. FIGS. 12A to 12C show a composition gesture pattern indicating to a composition where a face pattern of a command object is enlarged in a picture image according to an exemplary embodiment of the inventive concept. In those drawings, the left-side images represent command images 700 wherein a command object 710 has a composition gesture pattern, and the right-side images represent picture images 900 having a composition corresponding to the composition gesture pattern and having a posing object 910.

Referring to FIGS. 10A to 10C, the left-side command images 700 each has a command object 710. The command object 710 has a command gesture pattern where two fist patterns are placed at substantially the same relative position with respect to the body pattern. The right-side picture images 900 each has a composition corresponding to the command gesture pattern. The right-side picture images 900 each has a center composition where a posing object 910 is located at the center of the picture image 900 and the posing object 910 is enlarged at different sizes compared to the size of the command object 710,

Referring to FIG. 10A, the command image 700 includes the command object 710 whose command gesture pattern has a combination of two fully-stretched positions. The picture image 900 has a composition template corresponding to the command gesture pattern of FIG. 10A. The selected composition template has the posing object 910 placed at the center of the picture. The posing object 910 has a relative size according to the selected composition template. Depending on the distance from the camera 100 of FIG. 1, the camera 100 of FIG. 1 zooms in or out the posing person 200′ so that the posing object 910 has the relative size with respect to the background according to the selected composition template.

Referring to FIG. 1013, the command image 700 includes the command object 710 whose command gesture pattern has a combination of two half-stretched positions. The picture image 900 has a composition where the posing object 910 is placed at the center of the picture image 900. The posing object 910 is enlarged at a predetermined size according to the composition. For example, when the posing object 910 is in an erected pose, the posing object 910 has a relative size in the picture image 900 to the extent that the enlarged posing object is fitted between the top boundary and the bottom boundary of the picture image. The extent of the enlargement is calculated by the relative size of the command object 710 and the predetermined size of the posing object 910 according to the selected composition template, in an exemplary embodiment, the composition includes a composition rule defining the relative size and location of the posing object 910 in the picture image.

Referring to FIG. 10C, the command image 700 includes the command object 710 whose command gesture pattern has a combination of two fist-down positions. The picture image 900 has a composition where an upper part of the posing object 910 is placed at the center of the picture image 900. The posing object 910 is enlarged at a predetermined size according to the composition. For example, when the posing object 910 is in an erected pose, the upper part of the posing object 910 has a relative size in the picture image 900 to the extent that the enlarged upper part of the posing object 910 is fitted between the top boundary and the bottom boundary. The upper part of the posing object 910 is defined by the fist pattern locations of the composition gesture pattern. The extent of the enlargement is determined by the relative size of the upper part of the command object 710. The upper part of the posing object 910 is defined by the fist pattern locations of the command object 710. The relative size of the upper part of the posing object is determined according to the selected composition template. The composition includes a composition rule defining the relative size and location of the upper part of the object in the picture image.

Referring to FIGS. 11A to 11C, the command image 700 includes the command object 710 whose command gesture pattern has a combination of two the fist patterns each having a different relative position from each other. The picture image 900 has a composition where the posing object 910 is placed at a location of the left side of the picture image 900. The posing object 910 is enlarged at a predetermined size according to the composition. For example, the posing objects 910 is in an erected pose, and the posing object 910 has a relative size in the picture image 900 according to the composition gesture pattern of the command object 710.

For example, the command object 710 of FIG. 11A has a command gesture pattern where the command object 710 has a left fist of a fully-stretched position and a right fist of a half-stretched position. For example, the command object 710 of FIG. 11B has a command gesture pattern where the command object 710 has a left fist of a fully-stretched position and a right fist of a fist-down position. For example, the command object 710 of FIG. 11C has a command gesture pattern where the command object 710 has a left fist of a half-stretched position and a right fist of a fist-down position. When the image processor unit applies the Rule of Thirds composition, the picture images of FIG. 11A to 11C have the posing object 910 placed in the leftmost third of the picture image 900. The composition is not limited thereto, and may have other compositions.

In the operation flow of FIG. 5 for a mechanical operation, the extent of shifting a photographic frame using a pan or tilt operation is determined by the relative location of the command object 710 and the predetermined location of the posing object 910 according to the selected composition template. In addition, the extent of the enlargement is determined by the relative size of the command object 710 and the predetermined relative size of the posing object 910 according to the selected composition template. In an exemplary embodiment, the composition includes a composition rule defining the relative size and location of the posing object 910 in the picture image. Depending on the relative size of the command object in the command image, the object is zoomed in or out.

In the operation flow of FIG. 6 for an image manipulation operation, a cropping region is selected on the command image 700 according to the selected composition template to generate the picture image 900.

Referring to FIGS. 11D to 11F, the command image 700 includes the command object 710 whose command gesture pattern has a combination of two different fist patterns. The picture image 900 has a composition where the posing object 910 is placed at a location of the right side of the picture image 900. The posing object 910 is enlarged at a predetermined size according to the composition. The posing object 910 is in an erected pose, and the posing object 910 has a relative size according to the composition gesture pattern of the command object 710.

The command object 710 of FIG. 11D has a command gesture pattern where the command object 710 has a left fist of a half-stretched position and a right fist of a fully-stretched position. The command object 710 of FIG. 11E has a command gesture pattern where the command object 710 has a left fist of a fist-down position and a right fist of a fully-stretched position. The command object 710 of FIG. 11F has a command gesture pattern where the command object 710 has a left fist of a fist-down position and a right fist of a half-stretched position. When the image processor unit 340 applies the Rule of Thirds composition, the picture images of FIG. 11D to 11F have the posing object 910 placed in the rightmost third of the picture image 900. The composition is not limited thereto, and may have other compositions.

In the operation flow of FIG. 5 for a mechanical operation, the extent of shifting a photographic frame using a pan or tilt operation is determined by the relative location of the command object 710 in the command image and the predetermined location of the posing object 910 in the picture image of the selected composition template. In addition, the extent of the enlargement is determined by the relative size of the command object 710 in the command image 700 and the predetermined size of the posing object 910 in the picture image 900 of the selected composition template. In an exemplary embodiment, the composition includes a composition rule defining the relative size and location of the posing object 910 in the picture image 900. Depending on the relative size of the command object 710 in the command image 700, the object is zoomed in or out.

In the operation flow of FIG. 6 for an image manipulation operation, a cropping region is selected on the command image. 700 according to the selected composition template to generate the picture image 900.

Referring to FIGS. 12A to 12C, the command image 700 includes the command object 710 whose fist patterns are close to a face pattern. The picture image 900 has a face composition where a face pattern of the posing object 910 is placed at a center row of the picture image 910. The relative horizontal location and size of the posing object 910 is determined by a composition gesture pattern of the command object 710.

For example, the command object 710 of FIG. 12A has a command gesture pattern where the command object 710 has its both fist patterns in a fist-up position. The face pattern of the posing object 910 of FIG. 12A is located at the center of the picture image 900 of FIG. 12A. The command object 710 of FIG. 12B has a command gesture pattern where the command object 710 has a left fist pattern of a fist-up position and a right fist pattern of a partially-extended-fist-up position. The face pattern of the posing object 910 of FIG. 12B is located at the right side of the picture image 900. The command object 71.0 of FIG. 12C has a command gesture pattern including a left fist pattern of a partially-extended-fist-up position and a right fist pattern of a fist-up position. The face pattern of the posing object 910 of FIG. 12C is located at the left side of the picture image 900.

Accordingly, the composition includes a composition rule defining a relative size and location of a face pattern of a posing object in a picture image.

In an exemplary embodiment, to generate the picture image 900 described above with reference to FIGS. 10A to 10C, FIGS. 11A to 11F, and FIGS. 12A to 12C, the image processor unit 430 of FIG. 2 performs the operation flow of FIG. 5 or FIG. 6. The image processor unit 430 performs a mechanical operation including a pan, tilt or zooming operation according to a selected composition template. The image processor unit 430 also performs an image manipulation operation on a posing image to generate a picture image according to a selected composition template. The image manipulation operation includes a cropping operation and/or a digital zooming operation. In an exemplary embodiment, a cropping operation may be followed by a digital zooming operation. In this case, the digital zooming operation enlarges a cropped region selected by the cropping operation using an image processing operation.

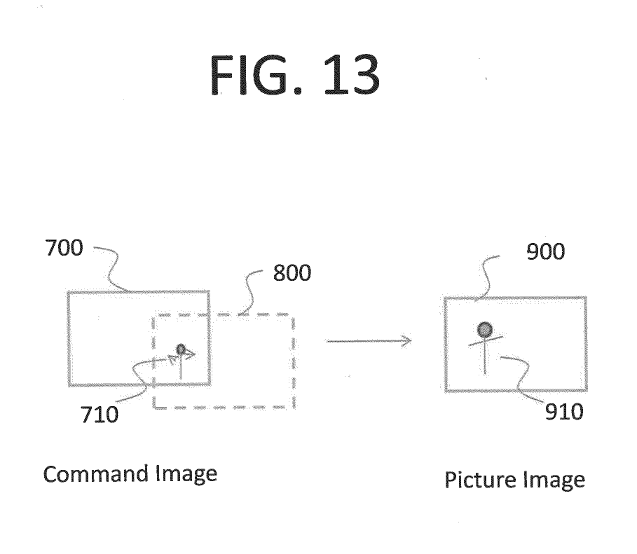

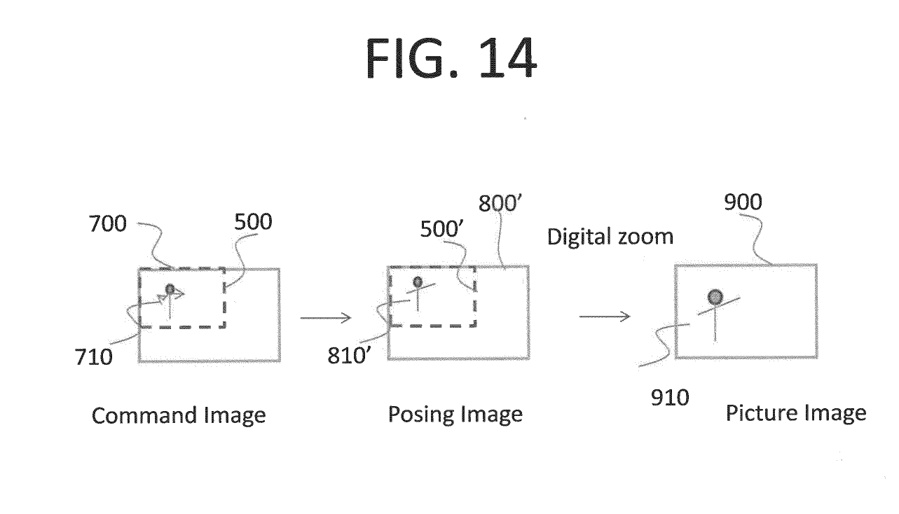

Hereinafter, the mechanical operation of the camera system 400 will be described with reference to FIG. 13. The image manipulation operation of the camera system 400 will be described with reference to FIG. 14.

FIG. 13 shows a mechanical operation of the camera system 400 of FIG. 2 according to an exemplary embodiment of the inventive concept.

Referring to FIG. 13, a command image 700 includes a command object 710 at its right bottom corner. The command image 700 has a command object 710 having a composition gesture pattern indicating to a composition template of a picture to be taken in a self-portrait photography mode. The command object 710 has a first relative size and location in the command image 700. The picture image 900 has a posing object 910 according to the composition template. The posing object 910 has a relative location and size defined in the composition template. The camera 100 of FIG. 1 changes its photographic frame directed toward the command person 200 or performs a zooming operation so that the picture image 900 has the selected composition template of the picture image 900.

Changing of the photographic frame of the camera 100 of FIG. 1 is performed using a mechanical operation including a pan or tilt operation. The image processor unit 430 of FIG. 2 calculates camera parameter values for a pan or tilt operation using the relative location of the command object 710 and the relative location of the posing object 910 in a composition template for the picture image 900. For example, the command object 710 located at the right bottom corner is shifted to the left side of the picture image 900 by a pan or tilt operation.

For the zooming operation, the image processor unit 430 of FIG. 2 calculates a camera parameter for a zooming operation such as zooming scale. The zooming scale is calculated using the relative size of the command object 710 and the relative size of the posing object defined in the composition template for the picture image 900.

FIG. 14 shows an image manipulation operation of the camera system 400 of FIG. 2 according to an exemplary embodiment of the inventive concept.

Referring to FIG. 14, a command image 700 includes a command object 710 at its left top corner. The command image 700 has a command object 710 having a composition gesture pattern indicating to a composition template. The command object 710 has a first relative size and location in the command image 700. A picture image 900 has a posing object at the relative size and location according to the composition template that is selected by the composition gesture pattern of the command object 710.

For example, the image processor unit 430 operates a cropping operation followed by a digital zooming operation. The image processor unit 430 selects a cropping region 500 in the command image 700 according to the selected composition template. Depending on the relative size of the command object 710 in the command image 700, the image processor unit 430 calculates the dimension of the cropping region 500. The command object 710 is placed at a relative location in the cropping region 500 according to the selected composition template. When the camera 100 of FIG. 1 takes a picture, a posing image 800′ as a preliminary image of the picture image 900 is generated. The image processor unit 430 applies the cropping region 500 to the posing image 800′ to generate the picture image 900. The cropped region 500′ of the posing image 800′ is enlarged by a digital zooming operation to generate the picture image 900.

In an exemplary embodiment, the cropping region 500 has substantially the same aspect ratio with that of the picture image 900.

In an exemplary embodiment, the relative location of the command object 700 of FIGS. 13 and 14 is determined by a face or body pattern location.

Hereinafter, it will be described about an extended command object. When the camera 100 of FIG. 1 takes a photo of two or more persons in a self-portrait photography mode, the gesture-base control of FIG. 5 or 6 applies to an extended command object that is selected in various manners. An extended command object includes a single command object, a group of human objects including a single command object, or two command objects collaboratively having a composition gesture pattern. The image processor unit 430 treats the extended command object as the command object as described above. For example, the extended command object indicates to a composition using its composition gesture pattern. The relative location or size of the extended command object serves as the relative location and size of the command object as described above. An object that is not selected as part of the extended command object is treated as part of the background.

FIGS. 15A to 15D show an extended command object according to an exemplary embodiment of the inventive concept.

Referring to FIGS. 15A and 15B, a single object is selected as an extended command object. A command image 700 includes a single command object 710 and two non-command objects 720. The command object 710 has an activation or composition gesture pattern, and the non-command objects 720 do not have the activation or composition gesture patterns in a natural pose. The command object and the non-command objects are collectively referred as to a group of objects. A picture image 900 has a composition corresponding to a composition gesture pattern of the single command object 710.

In FIG. 15A, the single command object 710 has a command gesture pattern as shown in FIG. 10A and thus the corresponding posing object 910 is positioned at the center of the picture image 900. Accordingly, the picture image 900 has a center composition with respect to the posing object 910, but the picture image 900 has an off-center composition in light of the group of objects. In FIG. 15B, the single command object 710 has a command gesture pattern as shown in FIG. 11A and thus the corresponding posing object 910 is positioned at the left side of the picture image 900. Accordingly, the picture image 900 has an off-center composition with respect to the posing object 910, but the picture image 900 has a center composition in light of the group of objects.

The relative location and size of the single command object 710 only is used to calculate camera parameter values for a mechanical operation such as a pan, tilt or zooming operation or select a cropping region for an image manipulation operation.

In this case, the image processor unit 430 of FIG. 2 treats the selected single command object 710 only as the foreground and the remaining objects 720 not selected as a command object are treated as the background.

Referring to FIGS. 15C, a group of objects 710′ including a single command object 710 is selected as an extended command object. A command image 700 has a group of objects 710′ including a single command object 710. The relative location and size of the command object 710 are calculated using the extended command object 710′. The composition of a picture image 900 is determined using the composition gesture pattern of the single command object 710. The picture image 900 has a composition where the plurality of foreground objects 200′ is placed at the center of the picture image 900 according to the composition gesture pattern of the single command object 710 in the command image 700.

The single command object 710 has a command gesture pattern as shown in FIG. 10A and the relative size and location of the extended command object 710′ serves as the relative size and location of the single command object 710. The picture image 900 has a composition corresponding to a composition gesture pattern of the single command object 710. Accordingly, an extended posing object 910′ is positioned at the center of the picture image 900 in light of the group of objects. The extended posing object 910′ of the picture image 900 corresponds to the extended command object 710′ of the command image 700.

Camera parameters or a cropping region are calculated based on the relative size and location of the extended command object 710′.

Referring to FIG. 15D, two objects collaboratively having a composition gesture pattern is selected as an extended command object. A command image 700 includes two objects 710 collaboratively having a composition gesture pattern. An extended command object 710′ is formed of the two objects 910 each having one hand fist pattern and one object 720 positioned between the two objects 910. The objects included in the extended command object are treated as the foreground image of the command image 700, and an object 730 that is not included in the extended command object 710′ is treated as the background image of the command image 700.

The two objects 710 collaboratively serves as a command object having a command gesture pattern shown in FIG. 10A. Using the relative size and location of the extended command object 710′, the image processor unit 430 calculates camera parameter values for a mechanical operation such a pan, tilt or zooming operation or a cropping region for an image manipulation operation according to a composition template selected by the two objects 710. The picture image 900 has a composition corresponding to a composition gesture pattern of the command object 710 having two objects. Accordingly, a corresponding extended posing object 910′ is positioned at the center of the picture image 900.

The camera parameters or the cropping region is calculated based on the relative size and location of the extended command object 710′.

As described above, the camera system 400 has a plurality of pre-defined composition templates and takes a self-portrait picture having a pre-defined composition template that is remotely selected from the plurality of the pre-defined composition templates according to a hand gesture that a photographer makes. The camera system 400 also includes a graded composition mode where the camera system 400 provides a composition other than the pre-defined composition templates using a hand gesture. In addition, the camera system 400 also adjusts the composition template selected from the plurality of the pre-defined composition templates using the graded composition mode.

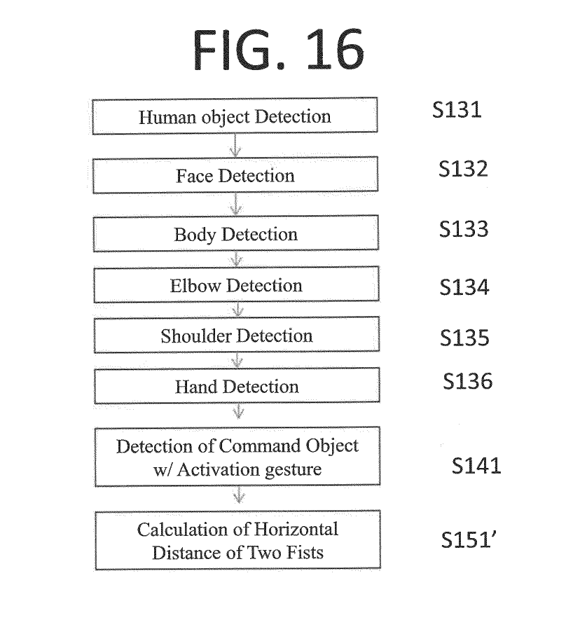

FIG. 16 shows a flowchart illustrating the graded composition mode according to an exemplary embodiment of the inventive concept. Referring to FIG. 16, the image processor unit 430 performs the steps S131 to the step S141 as shown in FIG. 7. At the steps S131 to S141, the image processor unit 430 detects a command object and then detects various body part patterns including two fists patterns, the elbow patterns, the shoulder patterns, and the face pattern. At the step S151′, the image processor unit 430 calculates a horizontal distance between each hand and the corresponding shoulder pattern, and normalizes the hand distance using a horizontal distance of a fully-stretched hand from the corresponding shoulder pattern. The image processor unit 430 estimates the horizontal distance of the fully-stretched hand from a shape of the command object.

In the graded composition mode, the image processor unit 430 of FIG. 2 perform the step 170 of FIG. 5 using the horizontal distance calculated at the step S151′. At the step 170 of FIG. 5, the image processor unit 430 compares the horizontal distance of a right hand and the horizon distance of a left hand. The horizontal location of the human object 610 of FIG. 8 in a picture image is a function of the ratio between the right hand distance D-right and the left hand distance D-left. When the right hand distance D-right is larger than the left hand distance D-left, the command object is located at the right side of the picture image. The location at the right side of the picture image is varied depending on the ratio. As the ratio increases, the command object is closer to the boundary at the right side of the picture image.

The relative size of the command object is a function of the sum of the right hand distance D-right and the left hand distance D-left. As the sum decrease, the relative size of the command object 610 increases. Alternatively, the image processor unit may calculate an inner angle of each elbow. In this case, as the sum of the inner angles decreases, the relative size of the command object increases.

In an exemplary embodiment, when the fist are located at the face level, the calculation as described above is performed using the face pattern location instead of the shoulder pattern location. In this case, the composition includes the upper part of the command person as shown in FIGS. 12A to 12C.

The self-portrait photography mode according to an exemplary embodiment need not be limited to a still camera function. For example, a video camera has the self-portrait photography mode as described above. In this case, a frame of a video image serves as a command image including a command object that controls a composition of frame to be taken.

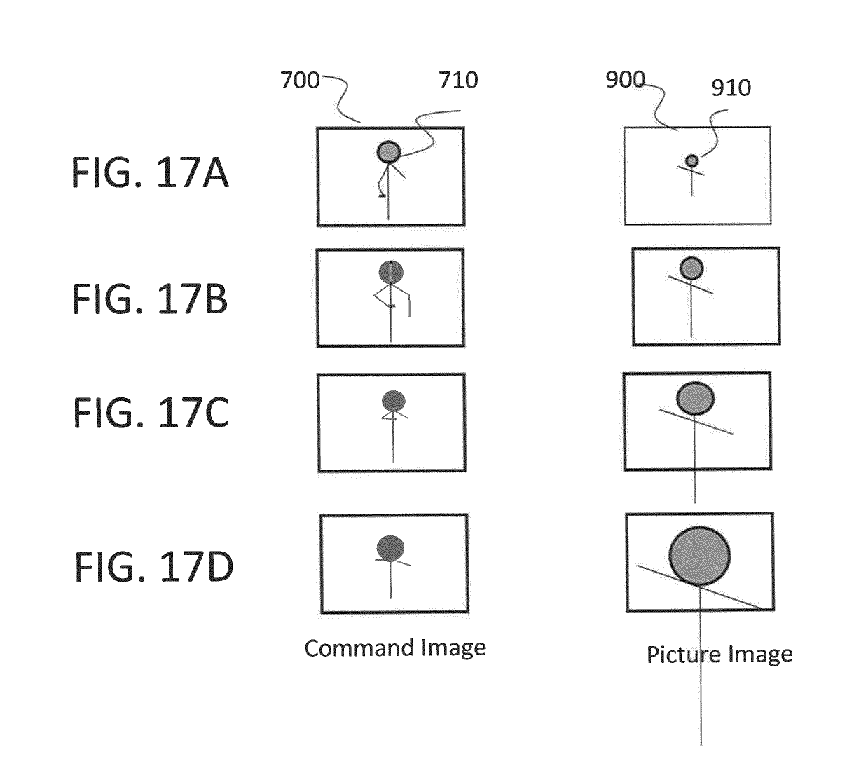

The self-portrait photography mode according to an exemplary embodiment need not be limited to a composition gesture pattern having two fists. For example, a composition gesture pattern has a single hand composition gesture pattern including, but not limited to, a fist pattern or a straight-open fingers. Using a single hand composition gesture pattern, a composition of a frame is remotely controlled for a video recording, as shown in FIGS. 17A to 17D.

FIGS. 17A to 17D show a single hand composition gesture pattern for controlling a basic shot of a video recording according to an exemplary embodiment of the inventive concept. For convenience of description, the basic shot includes, but is not limited to, a wide shot, a mid shot, a medium-close-up shot, or a close-up shot.

Referring to FIGS. 17A to 17D, the command object 710 has its straight-open fingers at different heights. The video system produces frames having a selected shot according to the composition gesture pattern. For example, the image processor unit 430, in response to the single hand composition gesture pattern of FIG. 17A, generates a picture image 900 having a wide shot as shown in FIG. 17A. The image processor unit 430, in response to the single hand composition gesture pattern of FIG. 17B, generates a picture image 900 having a mid shot as shown in FIG. 17B. The image processor unit 430, in response to the single hand composition gesture pattern of FIG. 17C, generates a picture image 900 having a medium-close-up shot as shown in FIG. 17C. The image processor unit 430, in response to the single hand composition gesture pattern of FIG. 17D, generates a picture image 900 having a close-up shot as shown in FIG. 17D.

Using an electronic device having a self-portrait photography mode according to an exemplary embodiment of the inventive concept, one or more persons take a picture thereof using a simple and intuitive hand gesture. The electronic device is remotely controlled to have a composition of a self-portrait picture to be taken before shooting.

While the present inventive concept has been shown and described with reference to exemplary embodiments thereof, it will be apparent to those of ordinary skill in the art that various changes in than and detail may be made therein without departing from the spirit and scope of the inventive concept as defined by the following claims.

What is claimed is:

1. A camera system for taking a self-portrait picture, comprising:
a buffer memory configured to store a first image and a second image; and
an image processor unit configured to:
detect a human object from the first image,
determine whether the human object is a command object,
detect a composition gesture pattern of the command object from the first image,
determine a composition of the self-portrait picture using the detected composition gesture pattern, and
generate the second image having a posing object, wherein the posing object is a same human object as the command object and has no composition gesture pattern.

2. The camera system of claim 1, wherein the image processor unit is further configured to select one of a plurality of composition templates to determine the composition, wherein each composition template includes information of a relative size and location of the posing object in the second image.

3. The camera system of claim 2, wherein the image processor unit is further configured to calculate a relative size and location of the command object in the first image.

4. The camera system of claim 3, wherein the image processor unit is further configured to calculate values of camera parameters using the relative size and location of the command object and a relative size and location of the posing object defined in the selected composition template, the camera parameters including parameters for pan control, zoom control, or tilt control.

5. The camera system of claim 4, wherein the camera parameters further includes parameters for exposure control or focus control.

6. The camera system of claim 2, wherein the second image has the selected composition template.

7. The camera system of claim 1, further comprising a non-volatile memory configured to store the second image in a compressed data format.

8. The camera system of claim 3, wherein the image processor unit is further configured to perform an image manipulation operation on the second image thereby generating a third image having the selected composition template.

9. The camera system of claim 8, wherein the image manipulation operation includes a cropping operation or a digital zooming operation.

10. The camera system of claim 9, wherein the cropping operation selects part of the second image, and a dimension and location of the part of the second image is determined using the relative size and location of the command object and a relative size and location of the posing object defined in the selected composition template.

11. The camera system of claim 10, further comprising a non-volatile memory configured to store the third image in a compressed data format.

12. The camera system of claim 1, wherein the command object has an activation gesture pattern of a predefined hand pattern in the first image, wherein the image processor unit is further configured to detect the predefined pattern from the first image.

13. The camera system of claim 12, wherein the predefined pattern includes two fist patterns of the command object.

14. The camera system of claim 1, wherein the composition gesture pattern includes a combination of relative positions of two fist patterns of the command object with respect to a face pattern of the command object or a body pattern of the command object.

15. The camera system of claim 14, wherein the relative positions of the two fist patterns includes a fully-stretched position, a half-stretched position, a fist-down position, a fist-up position, or a partially-extended-fist-up position.

16. The camera system of claim 1, wherein the image processor unit is further configured to generate a ready signal when the composition gesture pattern is detected.

17. The camera system of claim 16, wherein the ready signal includes a sound signal or a light signal.

18. The camera system of claim 16, wherein the image processor unit is further configured to generate a shooting command a predetermined time after the ready signal is generated.

19. The camera system of claim 18, wherein the second image is stored in the buffer memory after the shooting command is generated.

20. The camera system of claim 12, wherein a relative size of the command object is increased to include objects having no composition gesture patterns.

21. The camera system of claim 12, wherein when at least two human objects collaboratively have the activation gesture pattern, the command object includes the at least two human objects.

22. A camera system for taking a self-portrait picture, comprising:
a buffer memory configured to store a first image and a second image; and
an image processor unit configured to:
detect a human object from the first image,
determine whether the human object is a command object,
calculate a first horizontal distance of one hand pattern of the command object from a corresponding body or face pattern,
calculate a second horizontal distance of another hand pattern of the command object from the corresponding body or face pattern,
calculate values of camera parameters using the first and the second horizontal distance, and
generate the second image having a posing object,
wherein the posing object is a same human object as the command object.

23. The camera system of claim 22, wherein a relative horizontal location of the posing object in the second image is determined using difference of the first horizontal distance and the second horizontal distance.

24. The camera system of claim 22, wherein a relative size of the posing object in the second image is determined using sum of the first horizontal distance and the second horizontal distance.

25. A method of controlling a camera system for taking a self-portrait picture, the method comprising:
receiving first scene information using a first photographic frame;
storing a first image, corresponding to the first scene information, in a buffer memory;
detecting a human object from the first image;
determining whether the human object is a command object, the command object having an activation gesture pattern of a predefined hand pattern;
when the command object is detected, detecting a composition gesture pattern from the command object, wherein the composition gesture pattern is one of a plurality of predefined hand gesture patterns; and
selecting one of a plurality of composition templates corresponding to the detected composition gesture pattern, wherein each composition template corresponds to each predefined hand gesture pattern.

26. The method of claim 25, further comprising:
generating a ready signal after the selecting of the one of the plurality of the composition templates.

27. The method of claim 25, wherein the detecting of the human object comprises:
dividing the first image into a foreground image and a background image; and
detecting the human object from the foreground image.

28. The method of claim 27, further comprising:
detecting a face pattern of the human object;
detecting a body pattern of the human object;
detecting a hand pattern of the human object; and
determining whether the hand pattern matches the predefined hand pattern, wherein when the hand pattern matches the predefined hand pattern, the human object is treated as command object.

29. The method of claim 28, wherein the detecting of the composition gesture pattern further comprises:
calculating a relative position of the hand pattern with respect to the face pattern or the body pattern.

30. The method of claim 29, wherein the relative position of the hand pattern includes a fully-stretched position, a half-stretched position, a fist-down position, a fist-up position, or a partially-extended-fist-up position.

31. The method of claim 25, further comprising calculating a relative location and size of the command object in the first image.

32. The method of claim 31, further comprising:
calculating values of camera parameters using the relative size and location of the command object and a relative size and location of the posing object that is defined in the selected composition template;
shifting the first photographic frame to a second photographic frame based on the calculated camera parameter values;
receiving second scene information using the second photographic frame; and
storing a second image having a posing image, wherein the posing image is a same human object as the command object.

33. The method of claim 26, wherein when at least one of the calculated camera parameter values is out of an allowable range, an out-of-range signal is generated.

34. The method of claim 31, further comprising:
receiving second scene information using the first photographic frame;
storing a second image having a posing object, wherein the posing object is a same human object as the command object.
calculating a cropping region using the relative size and location of the command object and a relative size and location of the posing object that is defined in the selected composition template;
performing a cropping operation, using the cropping region, on the second image to generate a third image.

35. The method of claim 34, further comprising a digital zooming operation on the cropped region of the second image to generate the third image.

36. The method of claim 34, wherein when the cropping region includes a region outside the command image, an out-of-bounds signal is generated.
